(19) United States
(12) Patent Application Publication
(10) Pub. No.: US 2015/0366250 A1
(43) Pub. Date: Dec. 24, 2015

(54) System and Method for Altering the Perceived Flavor of a Liquid or Vapor Passing into the Mouth

(71) Applicant: Steven M. Landau, Meadowbrook, PA (US)

(72) Inventor: Steven M. Landau, Meadowbrook, PA (US)

(21) Appl. No.: 14/308,687

(22) Filed: Jun. 18, 2014

(51) Int. Cl. A23L 1/22; A24F 1/30; A24F 47/00; A61C 17/00

(52) U.S. Cl. CPC A23L 1/22091; A61C 17/00; A24F 1/30; A24F 47/002

(57) ABSTRACT

A system and method of inducing sensory deception in a person eating, drinking or smoking a consumable product. When many products are eaten, drunk or smoked, those objects are taken into the mouth with a plastic object. The plastic object has a first segment and a second segment, wherein the first segment enters the mouth and the second segment remains under the nose just outside the mouth. Sensory deception is created by forming at least part of the first segment from plastic that has been combined with a gustatory perception modifier. Furthermore, the second segment is at least partially comprised of a plastic that has been combined with a selected scent. The modified plastic stimulates the sense of taste when entering the mouth. The second segment contains the scented plastic. This segment stimulates the olfactory sense. Together, the two segments create modified olfactory and gustatory inputs.

### BACKGROUND OF THE INVENTION

1. Field of the Invention

In general, the present invention relates to systems and methods of forming and using plastic objects that pass into the mouth when eating, drinking or smoking. More particularly, the present invention relates to such plastic objects that alter the perceived taste and/or aroma of the material being drunk, eaten, or smoked.

2. Prior Art Description

Obesity has become a major concern across the globe. It is well established that Obesity causes many diseases, including but not limited to, high blood pressure, diabetes, and heart disease. While there are many factors that contribute to obesity, industry experts have determined that the consumption of high calorie beverages is a major factor. The human body requires water for hydration. The human body requires no other liquid to be healthy. Water has no calories and, therefore, does not contribute to obesity. The introduction of high calorie beverages has dramatically increased the average caloric intake of people, even though people are not eating any more food. This contributes significantly to the rise of obesity rates.

Additionally, a lot of attention has been placed on trying to reduce salt content in prepared foods. Salt has been identified as a contributing factor of heart disease. Regardless, many foods are saturated with salt so that during consumption they give an improved salty taste to the tongue. Many food companies have tried to introduce foods which are lower in salt content, however, people continue to utilize an excess amount of salt. A need therefore exists to deliver a salty taste experience during consumption which does not actually introduce high levels of salt into the diet.

When it comes to water, in addition to having no calories, water has many other advantages over sweetened beverages. Pure water does not need refrigeration and contains no ingredients that can spoil or ferment. Consequently, a person can carry or store bottles of water in high temperature environments without concern as to the potability of the water.

The one disadvantage of drinking water is that water has no flavor. Furthermore, as water sits in a plastic bottle, especially in the heat on a hot day, the water picks up an undesirable taste from the plastic packaging. Of course, the flavor and scent of water can be improved by adding artificial flavors and scents to the water. However, this requires that additives be mixed with the water. The additives may also add calories to the water. As such, this solution is less than ideal.

In U.S. Pat. No. 6,045,833 to Landau, the inventor herein, a system was developed that adds a perceived scent and flavor to water, without adding any additives. In the '833 patent, a scented plastic is used on the outside of the water bottle. The scented plastic comes close to the nose when water is drunk from the bottle. The scented plastic fills a person's olfactory sense with scent. This tricks the brain into believing that the water being drunk is both scented and flavored. Olfactory sensory deception has also been used on packaging to enhance the perceived scent, and thus flavor, of packaged goods. Such packaging is exemplified in U.S. Patent Application Publication No. 2010/0055245 to Havekotte.

The Applicant has improved upon the technology of the above-cited references. The Applicant has discovered that the perception of taste can be further enhanced if a person's sense of taste experience is enhanced at the same time the person's olfactory sense perceives a modified scent. The triggering of the sense of taste is accomplished using a molded plastic that has been infused with a gustatory perception modifier. When the modified plastic is placed in the mouth, the tongue perceives gustatory perception modifier even when the item being consumed contains little or no flavor. The gustatory perception modifier is a compound that stimulates one or more of the sweet, sour, saltiness, bitterness and/or umami taste receptors on the tongue. When this modified stimulation of the taste buds is combined with a modified scent, both the sense of taste and the olfactory sense trick the brain into believing that the consumable being eaten, drunk or smoked has a certain flavor that it does not possess in reality.

Scented plastics and sweetened plastics have been used in various consumer products within the prior art. For example, tongue depressors have been molded from sweetened plastic. This makes a tongue depressor taste more like a lollypop and reduces the gag reflex in children. Tongue depressors made from sweetened plastic are exemplified by U.S. Pat. No. 5,897,492 to Feller, and U.S. Pat. No. 5,846,195 to Reis. Although tongue depressors do pass into the mouth, tongue depressors are not consumed or used during consumption. Thus, it will be understood that the scent of the plastic used in a tongue depressor does not alter the perceived flavor of any product that is consumed.

A need therefore exists for a system and method that delivers an improved taste experience by enhancing the combined senses of taste and smell. In this manner, a product being consumed can be given modified taste characteristics that are perceived by the brain, yet do not really exist. Plain consumables, such as water, can therefore be consumed and believed to have a bold flavor, without needing to add any additives to the consumable. Likewise, foods prepared with little or no salt can be enhanced with a perceived salty taste. This need is met by the present invention as described and claimed below.

### SUMMARY OF THE INVENTION

The present invention is a system and method of inducing modified sensory enhancement to a person eating, drinking or smoking a consumable product. When many products are eaten, drunk or smoked, those objects are taken to the mouth with a plastic object. Such plastic objects include capped bottles, plastic cups, plastic lids, fitments/bottle neck inserts, plastic spoons/forks, and inhalation mouthpieces. In all cases, such plastic objects have a first segment and a second segment, wherein the first segment enters the mouth and the second segment remains under the nose just outside the mouth.

In the present invention, sensory deception is created by forming at least part of the first segment from plastic that has been combined with a gustatory perception modifier. Furthermore, the second segment may be at least partially comprised of a plastic that has been combined with a selected scent. Thus, the plastic object can contain scented plastic and/or plastic that is infused with a gustatory perception modifier.

The plastic infused with the gustatory perception modifier is localized in a first segment of a plastic object that enters the mouth. The modified plastic stimulates the sense of taste when it enters into the mouth. A second segment of the plastic object can contain the scented plastic. This second segment stimulates the olfactory sense. Together, the two segments create false olfactory and taste inputs that trick the brain into perceiving flavor in the material being consumed.

### BRIEF DESCRIPTION OF THE DRAWINGS

For a better understanding of the present invention, reference is made to the following description of exemplary embodiments thereof, considered in conjunction with the accompanying drawings, in which:

FIG. 1 is a side view of a first exemplary embodiment of a closure on a bottle container;

FIG. 2 is a view of the first exemplary embodiment of FIG. 1 being brought to the mouth;

FIG. 3 is a perspective view of a second exemplary embodiment of a closure;

FIG. 4 is a cross-sectional view of a third exemplary embodiment of a closure for use on a cup container;

FIG. 5 is a cross-sectional view of a cup container;

FIG. 6 is a perspective view of a spoon;

FIG. 7 is a perspective view of a toothbrush;

FIG. 8 is a perspective view of a bottle container with a fitment; and

FIG. 9 is a perspective view of a hookah pipe tip.

### DETAILED DESCRIPTION OF THE DRAWINGS

Although the present invention system can be embodied in many ways, the embodiments illustrated show only a few possible configurations for the invented technology. These embodiments are selected in order to set forth some of the best modes contemplated for the invention. The illustrated embodiments, however, are merely exemplary and should not be considered limitations when interpreting the scope of the appended claims.

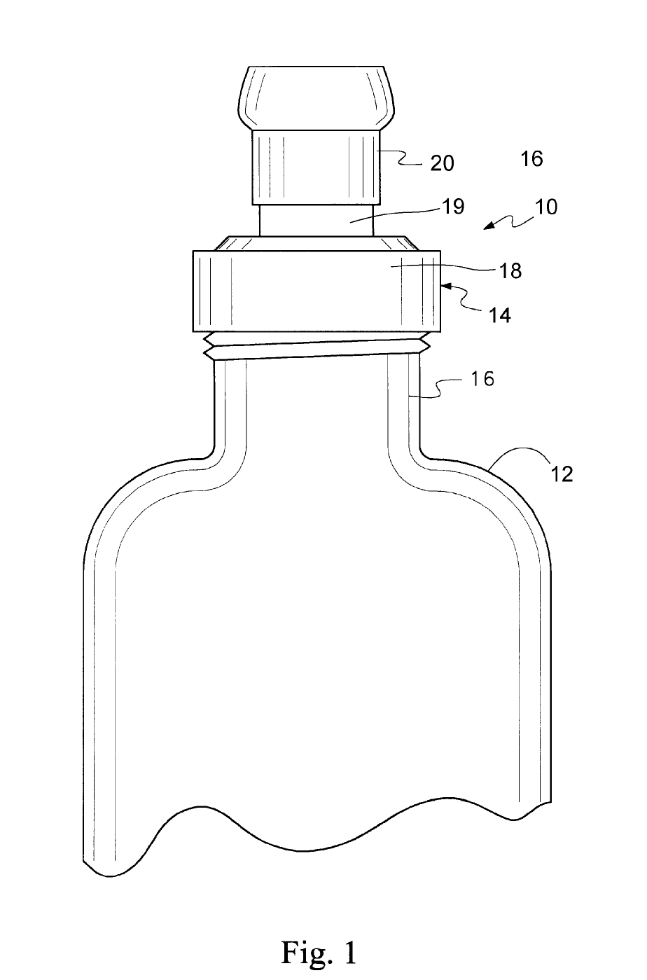

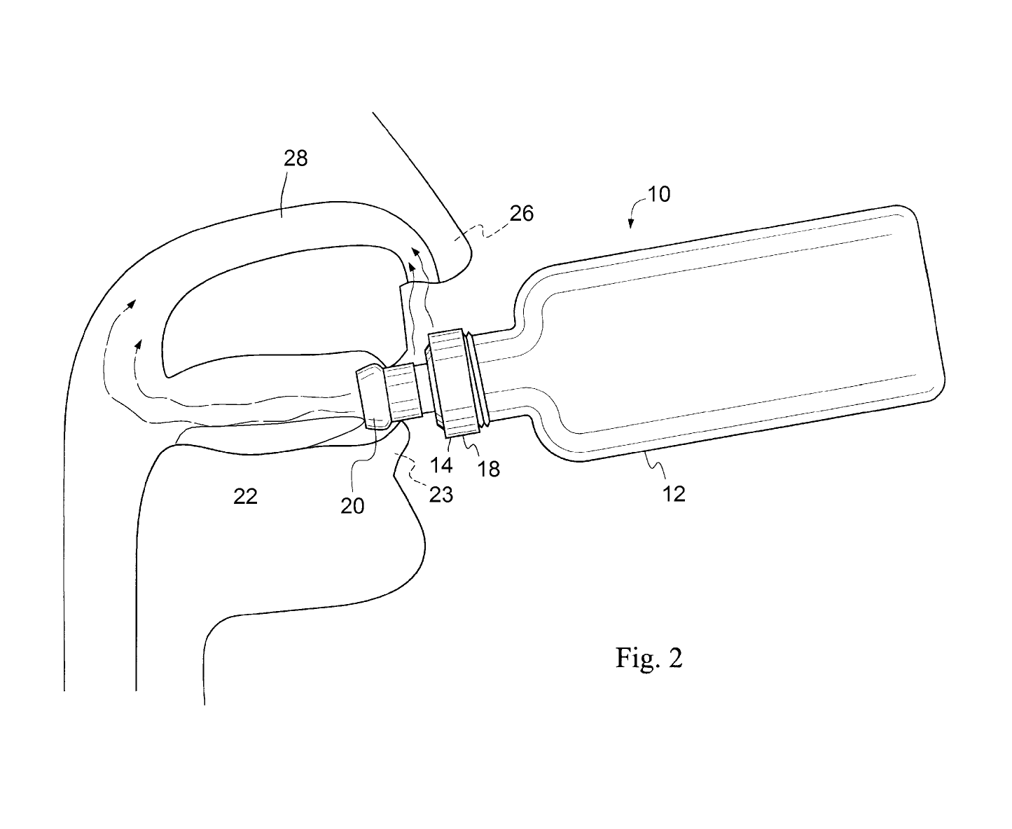

Referring to FIG. 1 in conjunction with FIG. 2, a container assembly 10 is shown. The container assembly 10 includes a bottle 12 for holding a liquid such as water and a closure 14 for accessing the liquid in the bottle 12. The bottle 12 has an open end at the top of a threaded neck 16. The closure 14 threads around the neck 16 of the bottle 12, thereby selectively obstructing the flow of liquid into and out of the bottle 12.

The closure 14 has a cap element 18 that threads onto the neck 16 of the bottle 12. A valve stem 19 is molded as part of the cap element 18. The valve stem 19 is hollow and provides a conduit through which fluid can exit the bottle 12 through the cap element 18. A nipple head 20 is provided. The nipple head 20 engages the valve stem 19 on the cap element 18. This produces an on/off valve that is controlled by the selective positioning of a nipple head 20 on the cap element 18.

The cap element 18 and the nipple head 20 are molded of two specialty plastic compositions. The cap element 18 is molded with plastic that is mixed with, or infused with, a selected scent. Thus, the cap element 18 is made of scented plastic. The nipple head 20 is molded from a plastic that is mixed with, or infused with, a gustatory perception modifier. The gustatory perception modifier can be a sweetener, a salt flavorant, a sour flavorant, a bitter flavorant and/or an umami flavorant. Thus, the nipple head 20 is molded from a flavored plastic. Acceptable gustatory perception modifiers can be selected from a group consisting of sucralose, stevia, aspartame, saccharin, cyclamate, salt, salt modifiers, spices, capsicum, and citric acid. It should be understood that these are examples and that persons skilled in the art may also use other such modifiers known to elicit a taste or mouth feel experience.

Formulations that produce scented plastics are well known. The scent used to produce the cap element 18 is preferably a scent that complements the beverage held within the bottle 12. For example, if the beverage is water, the selected scent can be that of a fruit. Likewise, if the beverage is unsweetened tea, then the selected scent can be that of lemon. The scent can be mixed with the plastic of the cap element 18 before molding, or infused into the plastic of the cap element 18 after molding.

The nipple head 20 is plastic that is mixed with, or infused with, a gustatory perception modifier. In the exemplary embodiment, it is assumed that the gustatory perception modifier is a sweetener. The preferred artificial sweetener is sucralose. However, other sweeteners, such as stevia, aspartame, saccharin, and cyclamate can be used. The sweeteners create a strong reaction with the sweet taste bud receptors at the tip of the tongue 22.

From FIG. 2, it can be seen that when a beverage is consumed out of the container assembly 10, the nipple head 20 passes into the mouth of the consumer. As such, the nipple head 20 contacts the lips 23 and tongue 22. As the tongue 22 touches the nipple head 20, the taste buds that detect sweetness are stimulated. The tongue 22, therefore, signals the brain that something sweet is being consumed. Simultaneously, the person's nose will detect the scent emanating from the cap element 18. This signals the brain that something flavorful and aromatic is being consumed. Since the cap element 18 is molded from a scented plastic, it will be understood that the air contained within the bottle 12 and the air surrounding the exterior of the cap element 18 contain the aroma of the scented plastic.

When a person wants to drink from the container assembly 10, the closure 14 is opened and is brought into contact with the mouth 20. When the closure 14 is brought to the mouth, a portion of the nipple head 20 passes into the mouth. Furthermore, as the closure 14 is brought into contact with the mouth, portions of the cap element 18 are inevitably brought into close proximity with the nose 26.

When portions of the cap element 18 are positioned directly outside of the nose 26, a strong scent is released into the air surrounding the nose 26. As such, should a person inhale through his/her nose between swallows, the intake of air contains the selected scent. Furthermore, since a portion of the cap element 18 is present inside the mouth, scented air fills the area within the mouth, wherein the scent enters the sinus cavity 28 from the mouth. The scent filled air contained within the mouth also mixes with exiting air as a person exhales through his/her nose 26. Furthermore, small amounts of the scent filled air are swallowed with the liquid being consumed. As a result, the scent is contained in any air that is inhaled and exhaled through the nose 26.

The person drinking from the container assembly, therefore, receives two modified sensory signals. Assuming water is being consumed, the water has no significant aroma or flavor of its own. However, when drank, the taste buds dedicated to detecting sweetness are stimulated by the sweetener in the nipple head 20. Likewise, the olfactory sense perceives the scent being emitted by the cap element 18. The combination of perception of sweetness and the perception of aroma tricks the brain into believing that the sweetness and aroma are associated with the beverage being consumed. Thus, the brain assigns the sweetness and aroma to the beverage, causing the beverage to present a realistic flavor to the brain. The taste of the beverage is therefore changed without having added a single additive to the beverage.

From the above, it can be understood that the same beverage can be flavored in different ways simply by placing different cap element 18 onto those beverage containers. This greatly simplifies the manufacturing logistics needed to create beverages in different flavors.

The saturation of the air within the mouth and the air surrounding the nose with the selected scent of the plastic greatly increases the ability of a person to perceive the aroma immediately before, during and immediately after swallowing. Simultaneously, the sweetened plastic of the nipple head 20 stimulates the taste buds on the tongue 22. As a result, a person drinking a bottle of pure water will believe that the water being consumed is flavored even though no flavoring or other chemicals have been added to the water.

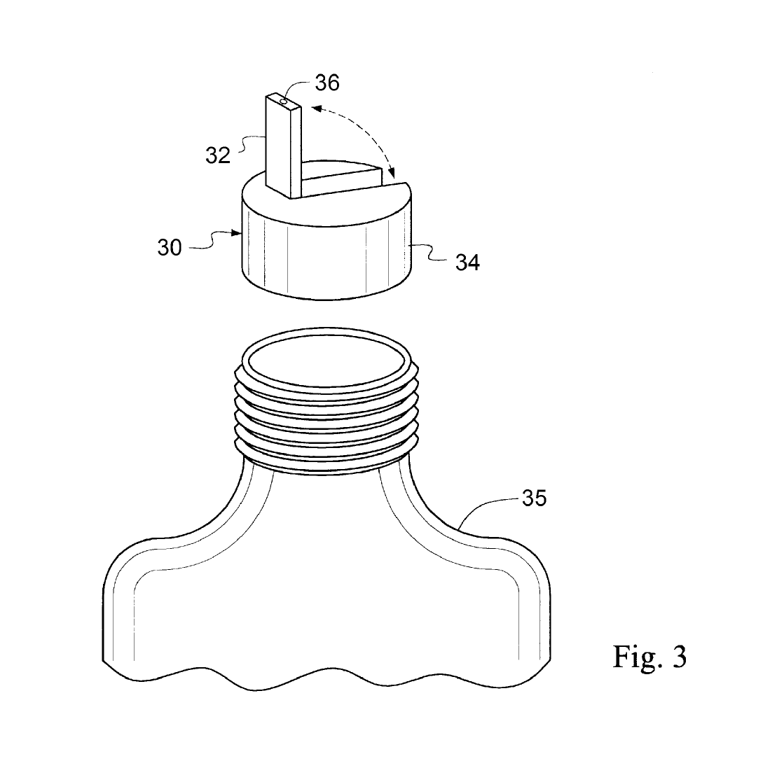

Referring to FIG. 3, an alternate embodiment of a closure 30 is shown having a connected straw element 32. The straw element 23 may be a pop-up straw, a flip up straw or an externally inserted straw. Closures of a similar construction are commonly used to cover containers of consumable fluid. The closure 30 includes a plastic base 34 that threadably attaches to the neck of a bottle 35. The straw element 32 defines a conduit 36 that is open when the straw element 32 is extended. To drink through the closure 30, a person extends the straw element 32 and drinks through the straw element 32.

The straw element 32 is molded from a plastic that is mixed, or infused with, a gustatory perception modifier. The base 34 is preferably fabricated from a plastic that is mixed, infused, or coated with a selected scent.

The straw element 32 is placed within the mouth when a person is drinking. As a result, the flavor modified plastic touches the lips and/or tongue while the scented plastic is positioned proximate the nose. The aroma of the plastic therefore fills the air within the sinus cavity while the taste buds are stimulated. This creates a more effective degree of sensory illusion that tricks the brain into perceiving taste in the liquid being consumed.

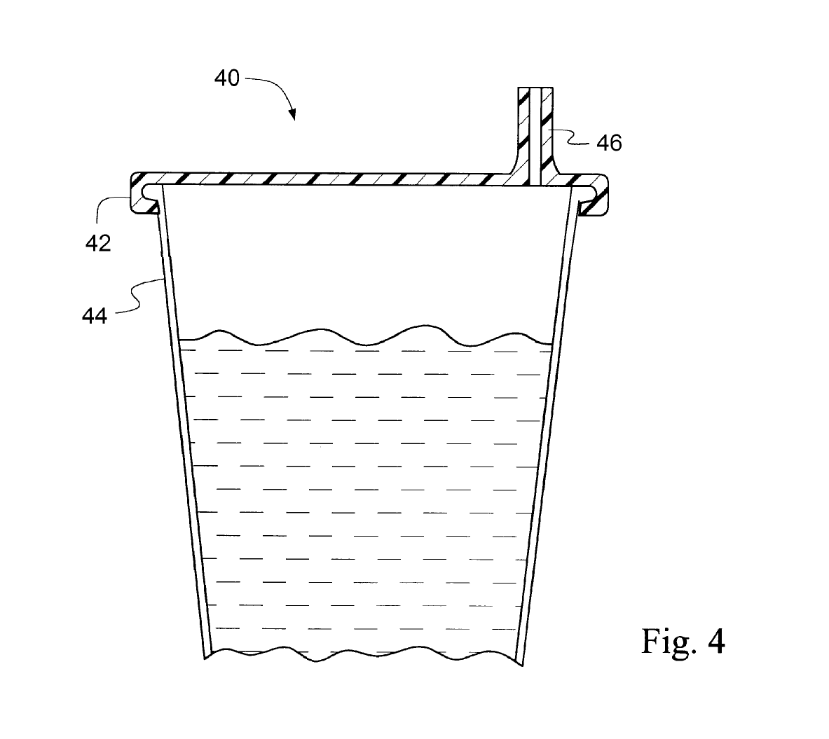

Referring to FIG. 4, a child's drinking cup assembly 40 is shown. The drinking cup assembly 40 contains a lid 42 that covers the base cup 44. An elongated conduit 46 extends upwardly from the lid 42. The elongated conduit 46 passes into a child's mouth when the child is drinking through the lid 42.

In the shown embodiment, the entire lid 42, including the elongated conduit 46 is molded of scented plastic. Furthermore, the tip 48 of the elongated conduit 46 is dip coated or otherwise manufactured with a gustatory perception modifier. Accordingly, when a child drinks from the cup assembly 40, part of the scented plastic of the lid 42 is positioned outside the nose and some of the scented and gustatory perception modifier from the elongated conduit 46 is held within the mouth. The aroma of the scented plastic therefore fills the air within the mouth and the air surrounding the nose, thereby leading to a more effective degree of aroma saturation. Additionally, the air contained within the base cup 44 is scented by its close proximity with the lid 42. As liquid is drunk from the cup assembly 40, some of the scented air from within the base cup 44 travels with the liquid into the mouth. The scented air mixes with the air within the mouth, thereby resulting in a stronger scent present within the mouth. These aroma features along with the stimulation of the taste buds from the flavor modified plastic of the tip 48 result in a more effective degree of olfactory sense illusion for the reasons previously described.

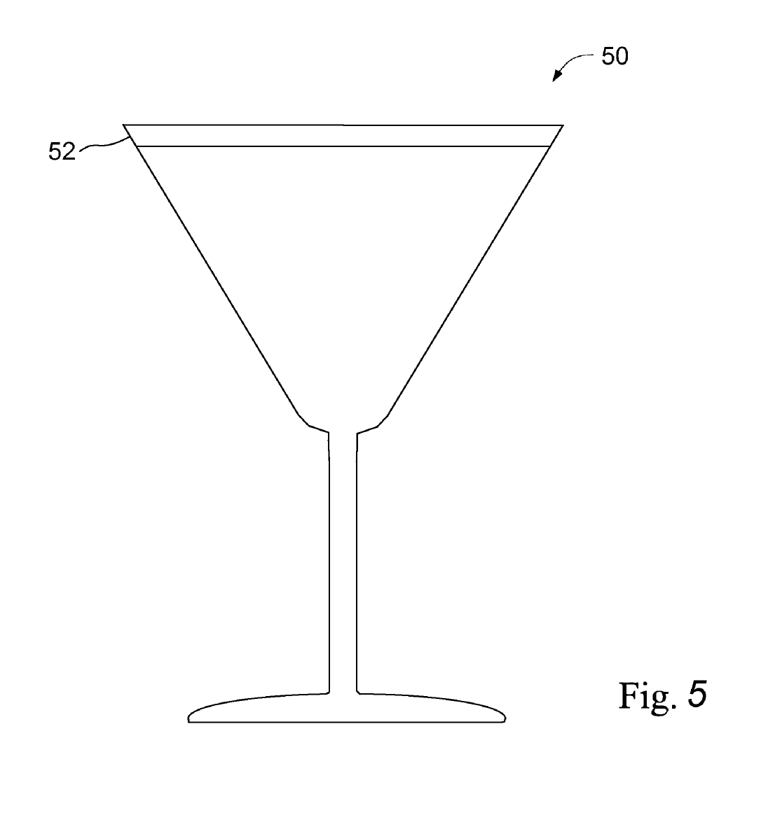

Referring to FIG. 5, an open cup receptacle 50 is shown. The cup receptacle 50 can contain scented plastic, but it need not. The cup receptacle 50 has a rim 52. The rim 52 of the cup receptacle 50 contains flavor modified plastic made with gustatory perception modifiers or is coated in a wax that contains gustatory perception modifiers.

As a person drinks from the cup receptacle 50, the rim 52 of the cup 50 enters the mouth. The aroma from the scented material, if present, fills the air within the mouth as well as the air surrounding the nose. Simultaneously, the flavor modified plastic at the rim 52 that contains the gustatory perception modifiers stimulates the taste buds. This results in a more effective degree of olfactory sense illusion for the reasons previously described.

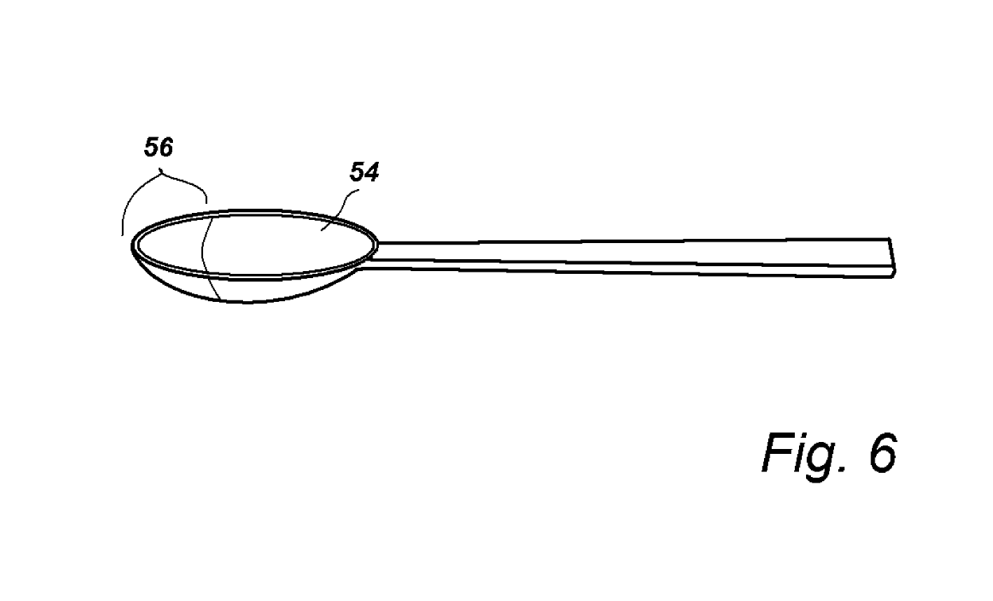

Referring to FIG. 6, a plastic spoon 54 is shown. The spoon 54 is molded from scented plastic. The tip 56 or entire spoon 54 is fabricated from a flavor modified plastic that is made from a mix of plastic and gustatory perception modifiers.

As a person uses the spoon 54, the tip 56 of the spoon 54 enters the mouth. The aroma from the scented material of the spoon 54 therefore fills the air within the mouth as well as the air surrounding the nose. Simultaneously, the tip 56 of the spoon 54 containing the gustatory perception modifier stimulates the taste buds. This results in a more effective degree of olfactory sense illusion for the reasons previously described.

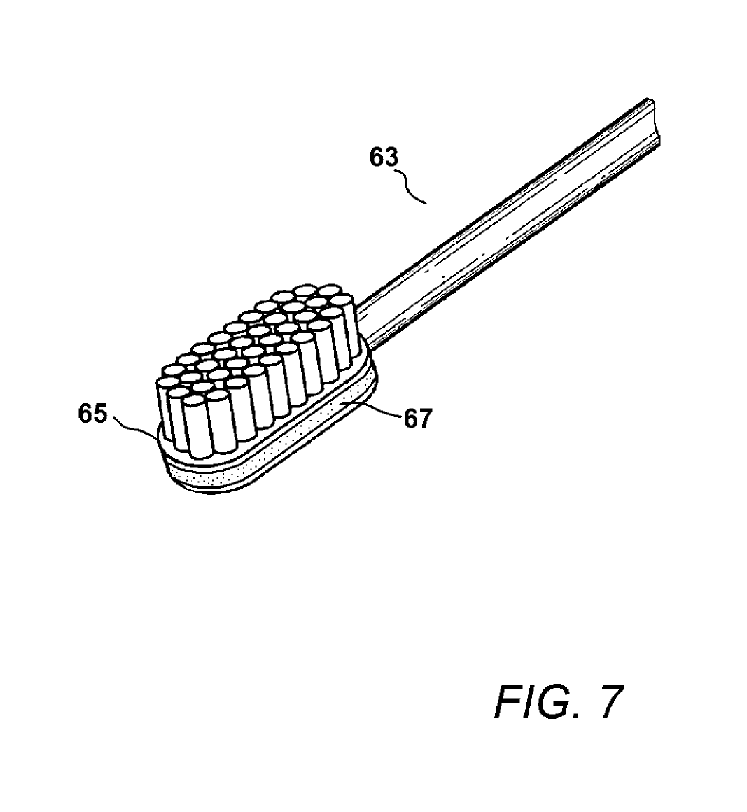

Referring to FIG. 7, a toothbrush 63 is shown. The toothbrush 63 has a head 65 that is molded from scented plastic. A flavor strip 67 is provided on the head 64. The flavor strip 67 is fabricated from a flavor modified plastic that is made from a mix of plastic and gustatory perception modifiers.

As a person uses the toothbrush 63, the flavor strip 67 on the toothbrush 63 enters the mouth. The aroma from the scented material of the head 65 therefore fills the air within the mouth as well as the air surrounding the nose. Simultaneously, the flavor strip 67, containing the gustatory perception modifier, stimulates the taste buds. This results in a more effective degree of olfactory sense illusion for the reasons previously described.

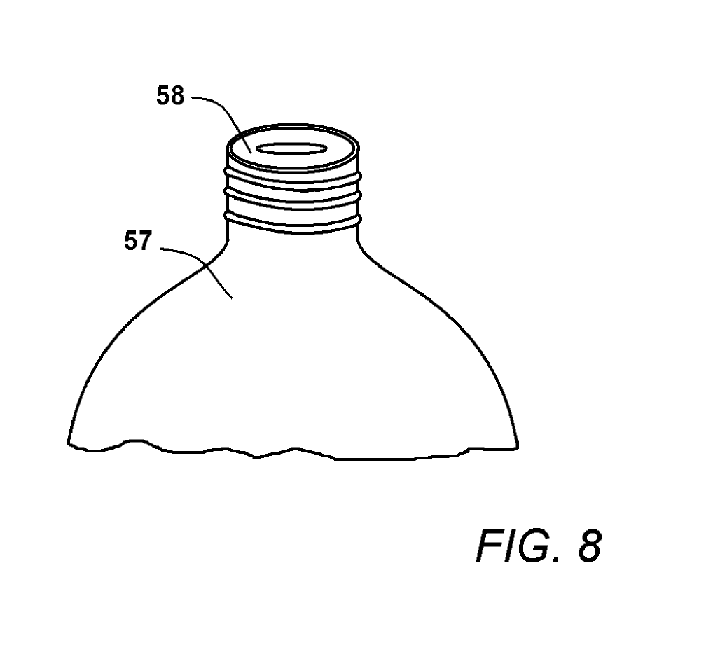

Referring to FIG. 8, a plastic bottle container 57 is shown. The plastic bottle container 57 has a fitment 58 that attaches to the neck of the bottle container 57. The fitment 58 is molded from scented plastic. The fitment 58 or portion thereof is fabricated from a flavor modified plastic that is made from a mix of plastic and gustatory perception modifiers.

As a person uses the plastic bottle container 57, the fitment 58 enters the mouth. The fitment 58 contains the gustatory perception modifier and stimulates the taste buds. This results in a more effective degree of gustatory enhancement for the reasons previously described.

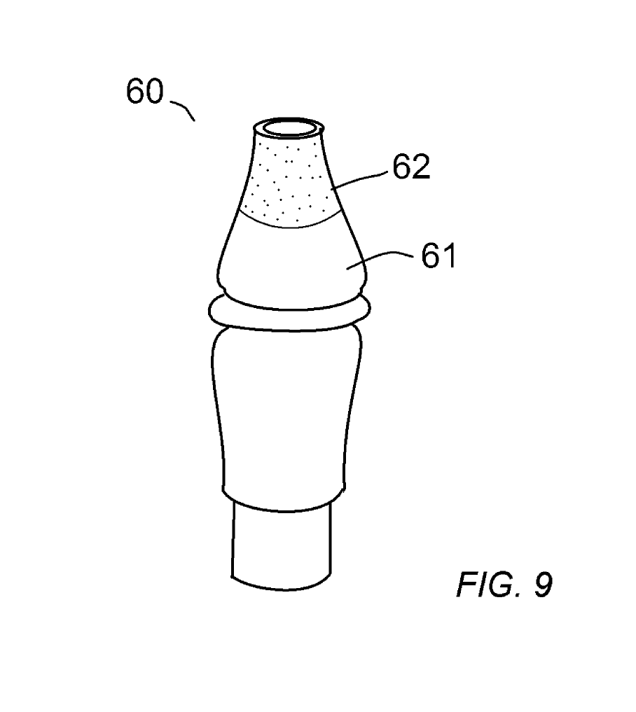

Lastly, referring to FIG. 9, a hookah tip 60 is shown. The hookah tip 60 can be part of a hookah pipe, or can be the end of similar smoking product like an e-cigarette. The hookah tip 60 has a body 61 that is molded from scented plastic. The body 61 of the hookah tip 60 has an inhalation end 62. The inhalation end 62 is either molded from, or dipped in, sweetened plastic. The sweetened plastic is made from plastic and artificial sweeteners.

As a person smokes from the hookah tip 60, the inhalation end 60 of the hookah tip 60 enters the mouth with a portion of the body 62. The aroma from the scented material of the body 61 therefore fills the air within the mouth as well as the air surrounding the nose. Simultaneously, the hookah tip 60 containing the artificial sweetener at the inhalation end 62 stimulates the taste buds. This results in a more effective degree of olfactory and gustatory enhancement for the reasons previously described.

It will be understood that the embodiments of the present invention described and illustrated herein are merely exemplary and a person skilled in the art can make many variations to the embodiments shown without departing from the scope of the present invention. It should also be understood that the various elements from the different embodiments shown can be mixed together to create alternate embodiments that are not specifically described. All such variations, modifications and alternate embodiments are intended to be included within the scope of the present invention as defined by the appended claims.

What is claimed is:

1. A method of inducing modified sensory enhancement to a person drinking a fluid from a receptacle, said method comprising the steps of:
providing a closure for a receptacle, said closure having a first segment and a second segment, wherein said closure enables fluid from within said receptacle to be drunk through said closure by placing said first segment of said closure in a person's mouth while said second segment of said closure remains external of the mouth,
wherein said first segment is comprised at least in part of a plastic that has been combined with an gustatory perception modifier; and
wherein said second segment is comprised at least in part of a plastic that has been combined with a selected scent; and
wherein said first segment stimulates a sense of taste while said second segment stimulates a sense of smell, therein creating said modified sensory enhancement while said fluid is being consumed.

2. The method according to claim 1, wherein said first segment is also comprised, at least in part, of said plastic that has been combined with said selected scent.

3. The method according to claim 1, wherein said receptacle is a bottle with a threaded neck and said closure is a bottle closure that engages said threaded neck.

4. The method according to claim 1, wherein said receptacle is a cup and said closure is a cup lid.

5. The method according to claim 1, wherein said gustatory perception modifier is selected from a group consisting of sucralose, stevia, aspartame, saccharin, cyclamate, salt, salt modifiers, spices, capsicum, and citric acid.

6. The method according to claim 1, wherein said receptacle is a water bottle and said fluid is water.

7. The method according to claim 1, wherein said second segment of said closure is a valve cap and said first segment of said closure is a nipple head that moves on said valve cap.

8. The method according to claim 1, wherein said second segment of said closure is a cap and said first segment of said closure is a straw element that extends into said valve cap.

9. A method of inducing modified sensory enhancement in a person consuming a product from an open receptacle, said method comprising the steps of:
providing a receptacle having a first section and a second section, wherein said first section passes into a person's mouth when said product is being consumed, while said second section remains external of the mouth,
wherein said first section is comprised at least in part of a plastic that has been combined with a gustatory perception modifier; and
wherein said second section is comprised at least in part of a plastic that has been combined with a selected scent; and
wherein said first section stimulates a sense of taste while said second section stimulates a sense of smell, therein creating said modified sensory enhancement while said product is being consumed.

10. The method according to claim 9, wherein said receptacle is a cup with a rim, wherein said first section includes said rim.

11. The method according to claim 9, wherein said receptacle is a spoon having a front tip, wherein said first section includes said front tip.

12. The method according to claim 9, wherein said gustatory perception modifier is a sweetener that is selected from a group consisting of sucralose, stevia, aspartame, saccharin, and cyclamate.

13. A method of inducing modified sensory enhancement in a person inhaling smoke and/or gases through a mouthpiece, said method comprising the steps of:
providing a mouthpiece having a body with an inhalation tip at one end, wherein said inhalation tip is comprised at least in part of a plastic that has been combined with a gustatory perception modifiers; and
wherein said body is comprised at least in part of a plastic that has been combined with a selected scent; and
wherein said inhalation tip stimulates a sense of taste while said body stimulates a sense of smell, therein creating said sensory deception while said gases are being inhaled.

14. The method according to claim 13, wherein said inhalation tip is also comprised, at least in part, of said plastic that has been combined with said selected scent.

15. The method according to claim 13, wherein said mouthpiece is the mouthpiece to a hookah pipe.

16. The method according to claim 13, wherein said mouthpiece is the mouthpiece to an electronic cigarette.

17. A method of inducing modified sensory enhancement in a person consuming a product, said method comprising the steps of:
providing a molded object used to transfer a consumable product into a user's mouth, where a first section of said molded object enters the mouth when said consumable product is consumed,
wherein said first section of said molded object is comprised at least in part, of a plastic that has been combined with a gustatory perception modifier.

18. The method according to claim 17, wherein a second section of said molded object is comprised at least in part of the plastic has been combined with a selected scent;
wherein said first section stimulates a sense of taste while said second section stimulates a sense of smell when said consumable product is consumed, therein creating a modified sensory enhancement.

19. The method according to claim 17, wherein said molded product is a toothbrush.

20. A method of inducing modified sensory enhancement in a person who is brushing his/her teeth, said method comprising the steps of:
providing a toothbrush that is used to transfer toothpaste into a user's mouth, wherein said toothbrush is comprised at least in part, of a plastic that has been combined with a gustatory perception modifier.
